(19) United States
(12) Patent Application Publication
(10) Pub. No.: US 2026/0043962 A1
(43) Pub. Date: Feb. 12, 2026

(54) OPTICAL ADAPTIVE ELECTRONIC STEERING ARRAYS

(71) Applicant: Raytheon Company, Tewksbury, MA (US)

(72) Inventors: Jae Hyun Kyung, Palo Alto, CA (US); Maurice J. Halmos, Encino, CA (US); Victor Leyva, Pasadena, CA (US)

(21) Appl. No.: 18/905,767

(22) Filed: Oct. 3, 2024

Related U.S. Application Data
(60) Provisional application No. 63/681,310, filed on Aug. 9, 2024.

(51) Int. Cl. G02B 6/12; G02B 6/124

(52) U.S. Cl. CPC G02B 6/12004; G02B 6/12002; G02B 6/1245; G02B 2006/12107; G02B 2006/12116; G02B 2006/12121; G02B 2006/12135

(57) ABSTRACT

An apparatus includes an array of tiles, where (i) each tile is configured to transmit or receive optical signals and (ii) each tile includes an array of photonic integrated circuit (PIC) antennas. The apparatus also includes a beam director configured to direct the optical signals to or from each of the tiles, where the beam director includes liquid crystal polarization gratings.

### CROSS-REFERENCE TO RELATED APPLICATION AND PRIORITY CLAIM

This application claims priority under 35 U.S. C. § 119(e) to U.S. Provisional Ser. No. 63/681,310 filed on Aug. 9, 2024, which is hereby incorporated by reference in its entirety.

### GOVERNMENT RIGHTS

This invention was made with U.S. government support. The government has certain rights in the invention.

### TECHNICAL FIELD

This disclosure generally relates to electronic devices. More specifically, this disclosure relates to optical adaptive electronic steering arrays.

### BACKGROUND

Electronic (non-mechanical) optical beam steering technology can be categorized into switchable grating/diffractive optics and optical phased arrays (OPAs). Switchable gratings can be effective at wide-angle tuning of an optical beam but have limited angular resolution. For some OPAs, phase modulation and control (beam shaping) may be done entirely by the photonic elements, but small pitch optical emitters utilized to obtain wide beam steering coverage can present scaling issues.

### SUMMARY

This disclosure relates to optical adaptive electronic steering arrays.

In some examples, an apparatus includes an array of tiles, where (i) each tile is configured to transmit or receive optical signals and (ii) each tile includes an array of photonic integrated circuit (PIC) antennas. The apparatus also includes a beam director configured to direct the optical signals to or from each of the tiles, where the beam director includes liquid crystal polarization gratings.

In other examples, a method includes operating an array of tiles, where (i) each tile transmits or receives optical signals and (ii) each tile includes an array of PIC antennas. The method also includes directing the optical signals to or from each of the tiles using a beam director, where the beam director includes liquid crystal polarization gratings.

In still other examples, a non-transitory machine readable medium includes instructions that when executed cause at least one processor to operate an array of tiles, where (i) each tile is configured to transmit or receive optical signals and (ii) each tile includes an array of PIC antennas. The instructions when executed also cause the at least one processor to direct the optical signals to or from each of the tiles using a beam director, where the beam director includes liquid crystal polarization gratings.

Any single one or any combination of the following features may be used with the examples above. The array of tiles may include multiple transmit tile arrays and multiple receive tile arrays. Each transmit tile array may represent a separate chip. Each receive tile array may represent a separate chip. The array of tiles may include one or more transmit tile arrays. Each transmit tile array may include a waveguide amplifier layer configured to be coupled to a master oscillator, a lenslet array, phase sensors, phase shifters, a bias control layer, and a cooling layer. Each transmit tile array may include a micro-optics layer having a lenslet array; a PIC antenna layer having the array of PIC antennas, phase shifters, and optical signal detectors; an interposer layer, a PIC amplifier layer having semiconductor optical amplifiers (SOAs) and phase shifters; a thermal interposer layer; and a direct drive integrated circuit (DDrIC) layer. The array of tiles may include one or more receive tile arrays. Each receive tile array may include a layer containing a lenslet array and optical signal detectors. The beam director may include multiple stages of liquid crystals. Each stage of liquid crystals may include a retardance layer and a polarization grating layer having at least one of the liquid crystal polarization gratings.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIGS. 1A-1B illustrate an example liquid crystal beam director in accordance with this disclosure;

FIGS. 2A-2C illustrate an example optical transmitter in accordance with this disclosure; and

FIGS. 3A-3C illustrate an example optical receiver in accordance with this disclosure.

### DETAILED DESCRIPTION

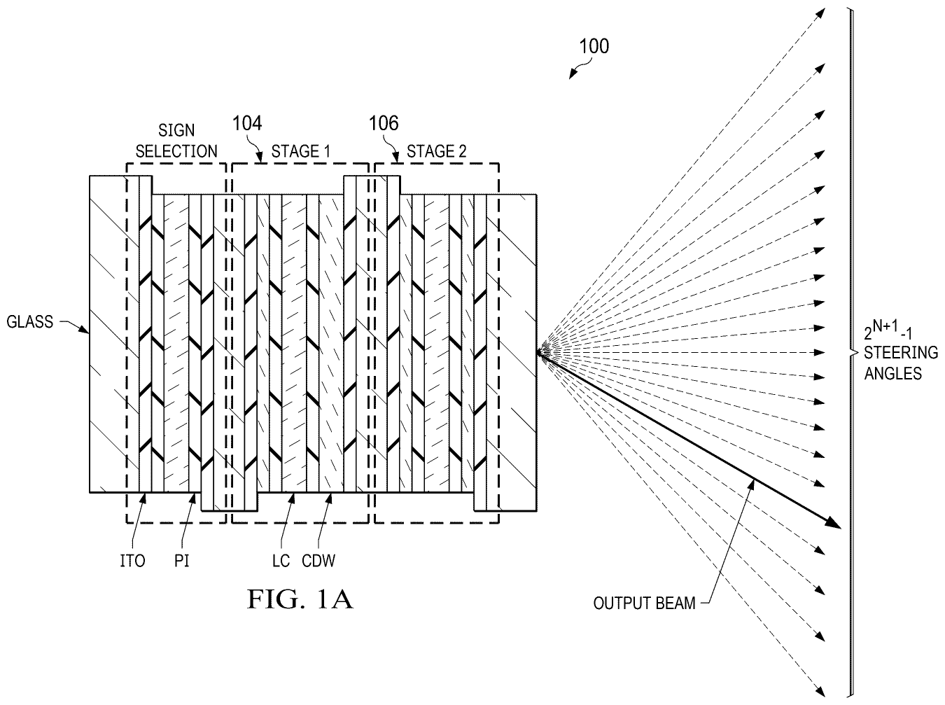

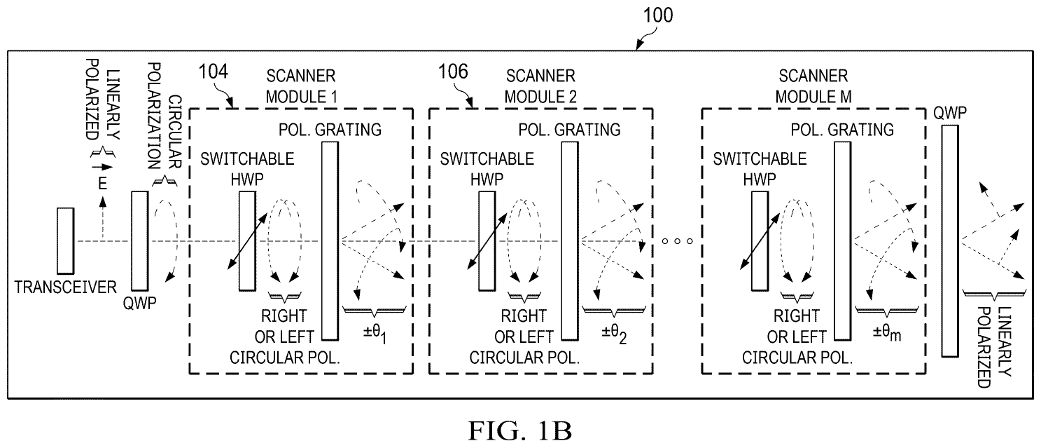

FIGS. 1A through 3C, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, electronic (non-mechanical) optical beam steering technology can be categorized into switchable grating/diffractive optics and optical phased arrays (OPAs) such as photonic integrated circuit (PIC)-based antenna arrays, spatial light modulators (SLM) or microelectromechanical (MEMS) arrays. Switchable gratings, like liquid crystal polarization gratings (LCPGs), are effective at wide-angle tuning of an optical beam but have limited angular resolution. For PIC-based OPAs, phase modulation and control (beam shaping) may be done entirely by the PIC array, but small pitch optical emitters utilized to obtain wide beam steering coverage can present scaling issues. Unlike SLM and MEMS based OPAs, PIC-based OPA provides their own emitters and do not utilize external light source(s) that are shaped and directed to the OPA. The present disclosure describes the use of PIC-based OPAs (referred to hereinafter as “OPAs”) with respect to various embodiments.

This disclosure provides hybrid optical beam steering architectures that utilize both LCPGs and OPAs. The hybrid architectures described here leverage the advantages of LCPGs and OPAs to provide compact optical beam steering devices with excellent steering resolution over a wide steering range. These optical beam steering devices may be utilized in numerous applications, such as laser illumination, and active sensing; adaptive optics; laser communications; laser altimeters (laser-based navigation); and laser-based Global Positioning System (GPS).

FIGS. 1A-1B illustrate an example liquid crystal beam director 100 in accordance with this disclosure. Liquid crystal beam directors allow for non-mechanical beam steering with low space, weight, and power (SWaP), large apertures, and wide steering angles. As shown in the cross-sectional view of FIG. 1A, beam director 100 includes stacks of multiple stages of liquid crystals. For example, it can be seen in FIG. 1A that beam director 100 includes first stage (“Stage 1”) 104 and second stage (“Stage 2”) 106. Each stage may include a selectable half or full wave retardance layer combined with a liquid crystal (LC) polarization grating layer. The LC polarization grating layer diffracts light, such as into either the +1 or −1 diffraction order, depending on whether the light is left-hand circularly polarized or right-hand circularly polarized as determined by the selectable phase retardance layer. The multiple stages are stacked together, where each stage increases the diffraction angle of a beam (such as by a factor of two). In some embodiments, a second set of stages may be added and aligned to allow for scanning in two dimensions. FIG. 1B illustrates an increasing diffraction angle between the multiple stages of LC polarization grating layers of liquid crystal beam director 100 including first stage 104 and second stage 106, as well as any number “M” of additional stages.

Although FIGS. 1A-1B illustrate one example of a liquid crystal beam director 100, various changes may be made to FIGS. 1A-1B. For example, while beam director 100 is illustrated with two stages of liquid crystal polarization gratings in FIG. 1A, beam director 100 may include any suitable number of liquid crystal polarization gratings. Also, while beam director 100 is illustrated as steering an output beam in FIG. 1A, beam director 100 may also be utilized to steer an input beam.

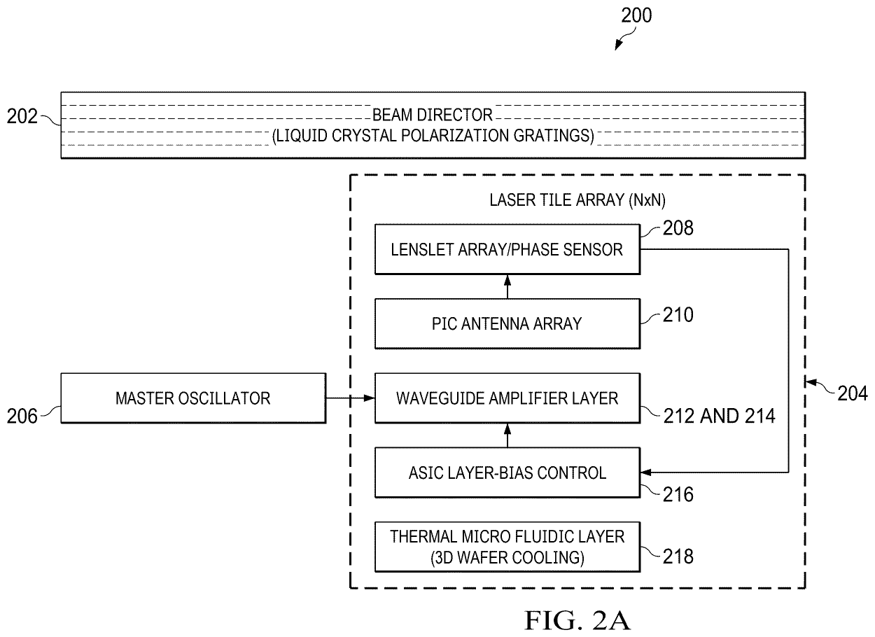

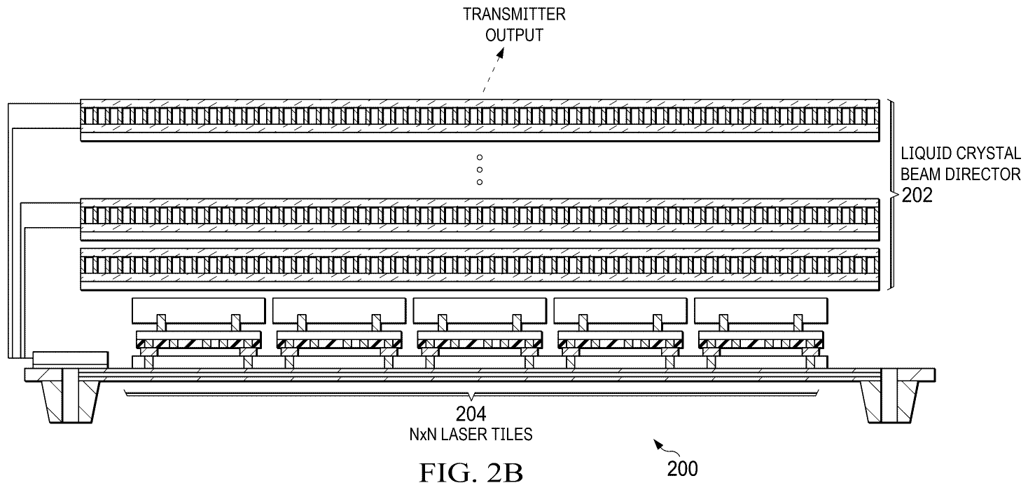

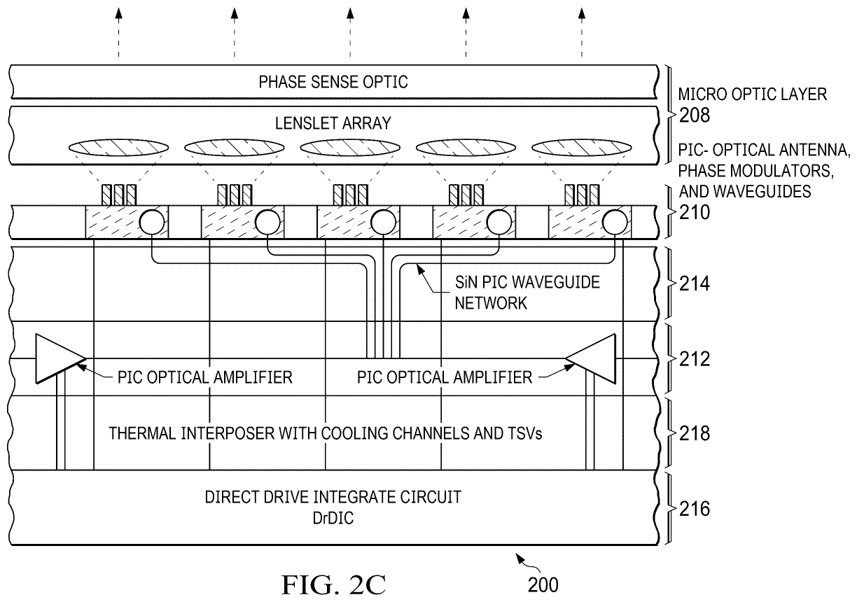

FIGS. 2A-2C illustrate an example optical transmitter 200 in accordance with this disclosure. More specifically, FIGS. 2A-2C illustrate optical transmitter 200 including an optical adaptive electronic steering array (AESA). FIG. 2A illustrates a functional block diagram of optical transmitter 200, FIG. 2B illustrates a side view of optical transmitter 200, and FIG. 2C illustrates a view of a single 3D stacked laser tile of optical transmitter 200.

As shown in FIGS. 2A-2C, optical transmitter 200 includes a beam director 202 and an N×N array 204 of laser tiles. The array 204 may include any suitable number and arrangement of laser tiles. For example, in some embodiments, optical transmitter 200 may include a 5×5 array 204 of laser tiles, giving a total array of 25 laser tiles. Each laser tile of array 204 is configured to transmit at least one optical signal. Beam director 202 includes liquid crystal polarization gratings and is configured to direct the optical signals from each of the laser tiles of array 204. Beam director 202 may be utilized for coarse steering (such as in 1° increments) of an optical beam generated by optical transmitter 200, and fine steering of the beam may be performed by array 204. In some embodiments, a single master oscillator laser 206 may seed each laser tile of array 204.

In some embodiments, beam director 202 includes stacks of multiple stages of liquid crystals similar as described regarding beam director 100 of FIGS. 1A-1B. For example, each stage may include a selectable half or full wave retardance layer combined with a liquid crystal (LC) polarization grating layer. In some embodiments, multiple stages are stacked together, where each stage is designed to increase diffraction angle (such as by a factor of two), similar as described regarding beam director 100 of FIGS. 1A-1B. In some embodiments, a second set of stages may be added and aligned to allow for scanning in two dimensions.

Each laser tile of array 204 may include a PIC antenna layer 210. PIC antenna layer 210 includes an array (such as a 256×256 array) of photonic integrated circuit (PIC) antennas (also referred to here as optical antennas) that outcouple light from PIC waveguides into free space. Each optical antenna may include a waveguide phase shifter that is used to adjust the relative phase across the chip for coherent beam combining and steering of the array. Each laser tile of array 204 may also include a micro-optics layer 208. Micro-optics layer 208 may include a 2D lenslet array, such as one that collimates light from each optical antenna from the lower PIC antenna layer 210. In some embodiments, the micro-optics layer 208 may include a panel-wide optical flat that covers the entire N×N panel, where individual tiles may be bonded to the optical flat. This panel may define a reference surface against which the tiles will be mechanically aligned and their phases referenced. In some embodiments, PIC waveguides that sample a fraction of the optical signal from each optical antenna within the PIC antenna layer 210 are combined into a single or several waveguide outputs or combined into a PIC interferometer or interferometers embedded in the PIC antenna layer 210 to provide one or more relative phase error signals to a detector or a set of detectors.

Each laser tile of array 204 may further include a PIC amplifier layer 212. PIC amplifier layer 212 takes light from the master oscillator laser 206, splits the light, and amplifies the light using an array of semiconductor optical amplifiers (SOA). In some embodiments, 3D interconnects (such as vertically coupled evanescent grating couplers) may be used to couple light from PIC amplifier layer 212 to the PIC antenna layer 210. Also, in some embodiments, phase adjusters may be incorporated before or after each SOA. Each laser tile of array 204 may also include a direct drive integrated circuit (DDrIC) layer 216. A DDrIC is an application specific integrated circuit (ASIC) or other circuit that conditions and controls electrical power delivered to the phase shifters and optical amplifiers in the PIC amplifier layer 212. The DDrIC layer 216 provides adjustable current or voltage to each phase shifter in the PIC amplifier layer 212, such as current control of the optical amplifiers to adjust the phase and bias control for phase shifters, and PIC antenna layer 210, such as for thermal or bias control of the phase shift of each optical antenna. In some embodiments, a small form factor field programmable gate array (FPGA) or other circuitry is integrated below the DDrIC layer 216, such as to continuously run a phase optimization algorithm for the tiles.

Each laser tile of array 204 may further include an interposer layer 214. The interposer layer 214 can be used between the PIC antenna layer 210 and the PIC amplifier layers 212. The interposer layer 214 may include low-loss silicon nitride waveguides and splitters, gratings, couplers or other type waveguides, splitters, or other components used to route light from the PIC amplifier layer 212 to each optical antenna. In some embodiments, interposer layer 214 contains deep through silicon vias (TSV) for electrical connection to the phase shifters of the optical antennas to the DDrIC layer 216. In addition, each laser tile of array 204 may include a thermal interposer layer 218. Thermal interposer layer 218 may be fabricated from silicon or other material(s) and patterned with microchannels carrying coolant. In some embodiments, thermal interposer layer 218 may also contain electrical TSVs for connecting DDrIC control lines to the layers 210 and 212.

Although FIGS. 2A-2C illustrate one example of an optical transmitter 200, various changes may be made to FIGS. 2A-2C. For example, while optical transmitter 200 is shown as having an N×N array of laser tiles 204 with five tiles visible (implying a 5×5 array), array 204 may be a non-square array (such as a 5×10 array) and may include any suitable number of tiles. Also, while beam director 202 shows three stages of liquid crystal polarization gratings, beam director 202 may include any suitable number of liquid crystal polarization gratings.

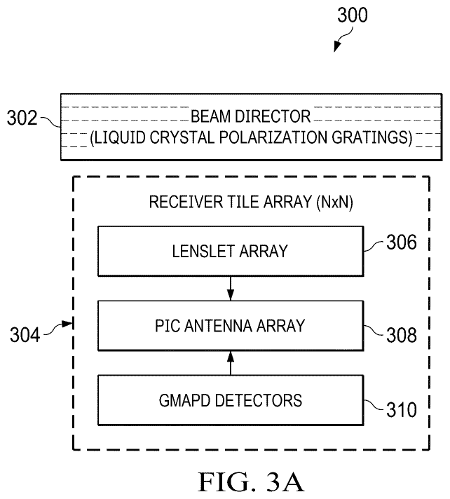

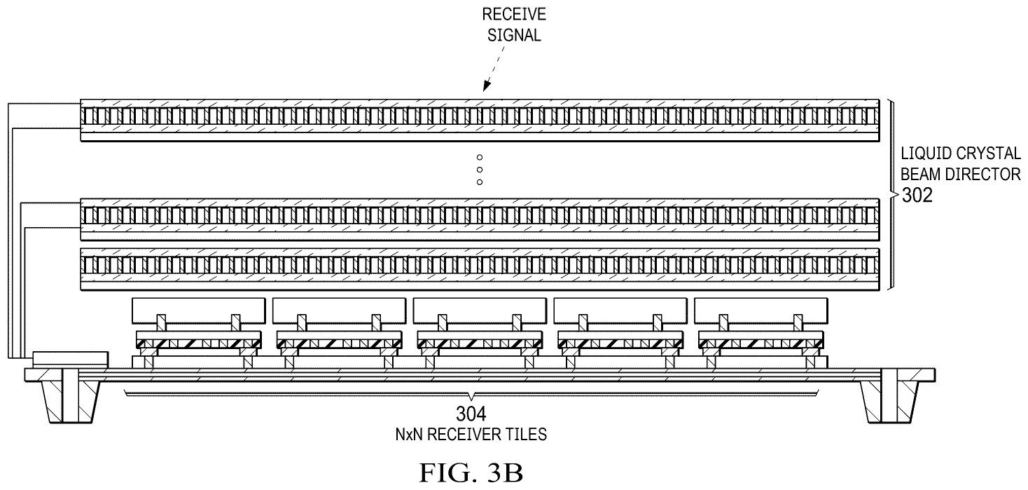

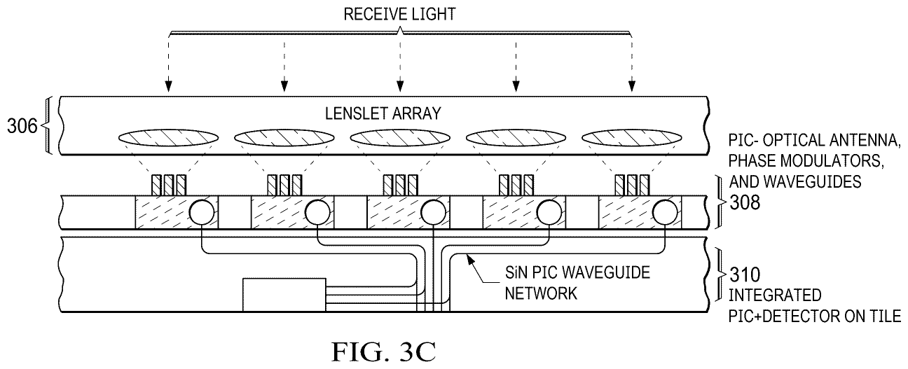

FIGS. 3A-3C illustrate an example optical receiver 300 in accordance with this disclosure. More specifically, FIGS. 3A-3C illustrate optical receiver 300 including an optical AESA. FIG. 3A illustrates a functional block diagram of optical receiver 300, FIG. 3B illustrates a side view of optical receiver 300, and FIG. 3C illustrates a view of a single 3D stacked receiver tile of optical receiver 300.

As shown in FIGS. 3A-3C, optical receiver 300 includes a beam director 302 and an N×N array 304 of receiver tiles. The array 304 may include any suitable number and arrangement of receiver tiles. For example, in some embodiments, optical receiver 300 may include a 5×5 array of receiver tiles, giving a total array of 25 receiver tiles. Each receiver tile of array 304 is configured to receive optical signals. Beam director 302 includes liquid crystal polarization gratings and is configured to direct optical signals to each of the receiver tiles of array 304. Beam director 302 may be utilized for coarse steering (such as in 1° increments) of a received optical beam (such as a beam generated by optical transmitter 200), and fine steering of the beam may be performed by array 304.

In some embodiments, beam director 302 includes stacks of multiple stages of liquid crystals similar as described regarding beam director 100 of FIGS. 1A-1B. For example, each stage may include a selectable half or full wave retardance layer combined with a liquid crystal (LC) polarization grating layer. In some embodiments, multiple stages are stacked together, where each stage is designed to increase diffraction angle (such as by a factor of two), similar as described regarding beam director 100 of FIGS. 1A-1B. In some embodiments, a second set of stages may be added and aligned to allow for scanning in two dimensions.

Each receiver tile of array 304 includes a PIC antenna layer 308 containing PIC antennas. For example, PIC antenna layer 308 may include optical antennas similar to those used in PIC antenna layer 210. In some embodiments, the optical antennas can operate bidirectionally to either transmit or receive light into a waveguide. Also, in some embodiments, the light coupled into the waveguide from the antennas is coupled into a high Finesse resonant waveguide narrow band optical filter, which can be used to reduce or minimize solar background counts for a wide field-of-view detector.

Each receiver tile of array 304 may also include a micro-optics layer 306. Micro-optics layer 306 may include a 2D lenslet array, such as one that couples received light from the beam director 302 into the optical antennas. In some embodiments, the coupled light from multiple optical antennas is combined into multi-mode waveguides in each receive tile. Also, in some embodiments, the multi-mode waveguides can be coupled to on-chip detectors 310. In some embodiments, the detectors 310 may represent Geiger-mode avalanche photodiode detectors (GM-APDs). In other embodiments, the light can be coupled into multi-mode fibers. The multi-mode fibers from each receiver tile can be combined to illuminate a GM-APD camera or array, such as detectors 310. Note that in some configurations, only range information may be captured, and there is little to no inherent cross-range imaging of objects by the receiver. However, with knowledge of the transmitter pointing, a scanning transmitter beam can be used to reconstruct cross-range information.

Although FIGS. 3A-3C illustrate one example of an optical receiver 300, various changes may be made to FIGS. 3A-3C. For example, while optical transmitter 300 is shown as having an N×N array of receiver tiles 304 with five tiles visible (implying a 5×5 array), array 304 may be a non-square array (such as a 5×10 array) and may include any suitable number of tiles. Also, while beam director 302 shows three stages of liquid crystal polarization gratings, beam director 302 may include any suitable number of liquid crystal polarization gratings.

Although FIGS. 2A-2C illustrate one example of an optical transmitter 200, and FIGS. 3A-3C illustrate and one example of an optical receiver 300, it should be understood that some embodiments may include a combination of the components depicted in FIGS. 2A-3C to form an optical transceiver that both transmits and receives optical signals, similar as described regarding FIGS. 2A-3C.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus comprising:
an array of tiles, each tile configured to transmit or receive optical signals, each tile comprising an array of photonic integrated circuit (PIC) antennas; and
a beam director configured to direct the optical signals to or from each of the tiles, the beam director comprising liquid crystal polarization gratings.

2. The apparatus of claim 1, wherein the array of tiles comprises:
multiple transmit tile arrays; and
multiple receive tile arrays.

3. The apparatus of claim 2, wherein:
each transmit tile array represents a separate chip; and
each receive tile array represents a separate chip.

4. The apparatus of claim 1, wherein:
the array of tiles comprises one or more transmit tile arrays; and
each transmit tile array further comprises:
a waveguide amplifier layer configured to be coupled to a master oscillator;
a lenslet array;
phase sensors;
phase shifters;
a bias control layer; and
a cooling layer.

5. The apparatus of claim 1, wherein:
the array of tiles comprises one or more transmit tile arrays; and
each transmit tile array comprises:
a micro-optics layer comprising a lenslet array;
a PIC antenna layer comprising the array of PIC antennas, phase shifters, and optical signal detectors;
an interposer layer;
a PIC amplifier layer comprising semiconductor optical amplifiers (SOAs) and phase shifters;
a thermal interposer layer; and
a direct drive integrated circuit (DDrIC) layer.

6. The apparatus of claim 1, wherein:
the array of tiles comprises one or more receive tile arrays; and
each receive tile array further comprises:
a layer containing a lenslet array; and
optical signal detectors.

7. The apparatus of claim 1, wherein the beam director comprises multiple stages of liquid crystals, each stage of liquid crystals comprising:
a retardance layer; and
a polarization grating layer comprising at least one of the liquid crystal polarization gratings.

8. A method comprising:
operating an array of tiles, each tile transmitting or receiving optical signals, each tile comprising an array of photonic integrated circuit (PIC) antennas; and
directing the optical signals to or from each of the tiles using a beam director, the beam director comprising liquid crystal polarization gratings.

9. The method of claim 8, wherein the array of tiles comprises:
multiple transmit tile arrays; and
multiple receive tile arrays.

10. The method of claim 9, wherein:
each transmit tile array represents a separate chip; and
each receive tile array represents a separate chip.

11. The method of claim 8, wherein:
the array of tiles comprises one or more transmit tile arrays; and
each transmit tile array further comprises:
a waveguide amplifier layer coupled to a master oscillator;
a lenslet array;
phase sensors;
phase shifters;
a bias control layer; and
a cooling layer.

12. The method of claim 8, wherein:
the array of tiles comprises one or more transmit tile arrays; and
each transmit tile array comprises:
a micro-optics layer comprising a lenslet array;
a PIC antenna layer comprising the array of PIC antennas, phase shifters, and optical signal detectors;
an interposer layer;
a PIC amplifier layer comprising semiconductor optical amplifiers (SOAs) and phase shifters;
a thermal interposer layer; and
a direct drive integrated circuit (DDrIC) layer.

13. The method of claim 8, wherein:
the array of tiles comprises one or more receive tile arrays; and
each receive tile array further comprises:
a layer containing a lenslet array; and
optical signal detectors.

14. The method of claim 8, wherein the beam director comprises multiple stages of liquid crystals, each stage of liquid crystals comprising:
a retardance layer; and
a polarization grating layer comprising at least one of the liquid crystal polarization gratings.

15. A non-transitory machine readable medium containing instructions that when executed cause at least one processor to:
operate an array of tiles, each tile transmitting or receiving optical signals, each tile comprising an array of photonic integrated circuit (PIC) antennas; and
direct the optical signals to or from each of the tiles using a beam director, the beam director comprising liquid crystal polarization gratings.

16. The non-transitory machine readable medium of claim 15, wherein:
the array of tiles comprises:
multiple transmit tile arrays; and
multiple receive tile arrays;
each transmit tile array represents a separate chip; and
each receive tile array represents a separate chip.

17. The non-transitory machine readable medium of claim 15, wherein:
the array of tiles comprises one or more transmit tile arrays; and
each transmit tile array further comprises:
a waveguide amplifier layer coupled to a master oscillator;
a lenslet array;
phase sensors;
phase shifters;
a bias control layer; and
a cooling layer.

18. The non-transitory machine readable medium of claim 15, wherein:
the array of tiles comprises one or more transmit tile arrays; and
each transmit tile array comprises:
a micro-optics layer comprising a lenslet array;
a PIC antenna layer comprising the array of PIC antennas, phase shifters, and optical signal detectors;
an interposer layer;
a PIC amplifier layer comprising semiconductor optical amplifiers (SOA) and phase shifters;
a thermal interposer layer; and
a direct drive integrated circuit (DDrIC) layer.

19. The non-transitory machine readable medium of claim 15, wherein:
the array of tiles comprises one or more receive tile arrays; and
each receive tile array further comprises:
a layer containing a lenslet array; and
optical signal detectors.

20. The non-transitory machine readable medium of claim 15, wherein the beam director comprises multiple stages of liquid crystals, each stage of liquid crystals comprising:
a retardance layer; and
a polarization grating layer comprising at least one of the liquid crystal polarization gratings.
